(19) United States
(12) Patent Application Publication
(10) Pub. No.: US 2006/0180789 A1
(43) Pub. Date: Aug. 17, 2006

(54) Formulation for corrosion and scale inhibition

(76) Inventors: Christopher Raymond Jones, SOUTH STAFFORDSHIRE (GB); Jason Mark Grech, Worcester (GB)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/550,156

(22) PCT Filed: Mar. 18, 2004
(86) PCT No.: PCT/GB04/01150

§ 371 Date: Mar. 23, 2006

(30) Foreign Application Priority Data
Mar. 21, 2003 (GB) 0306531.5

(51) Int. Cl. C02F 5/10

(52) U.S. Cl. 252/180

(57) ABSTRACT

A formulation comprising a THP⁺salt and a thio-substituted compound. The formulation is suitable for use in the treatment of corrosion and metal sulphide scale deposits in aqueous systems. The thio-substituted compound may be a thio-substituted carboxylic acid or salt, a thio-substituted sulphonic acid, a substituted or unsubstituted alkyl or aryl thiol, a thio-substituted heterocyclic compound or a mercaptoethanol.

The present invention relates to a method of preventing or alleviating the problems associated with metal sulphide deposits and to novel formulations for use in such a method.

Tetrakis (hydroxyorgano) phosphonium salts (hereinafter THP⁺salts), especially tetrakis (hydroxymethyl) phosphonium sulphate (hereinafter THPS) are widely used as metal sulphide dissolver/dispersers within aqueous systems and especially those systems associated with oilfields.

When THPS is used in oilfields, it is typically applied in concentrations of up to 30%, together with an ammonium salt to improve performance. This combination of THPS and an ammonium salt, together with high temperatures that can be experienced in oilfield applications, can be corrosive to mild steel and other metal components.

It is an aim of the present invention to ameliorate the above problems of corrosion by THP⁺salts when used in aqueous systems.

Accordingly, the present invention, in a first aspect, provides a formulation for use in the treatment of corrosion and metal sulphide scale deposits in aqueous systems, said formulation comprising a THP⁺salt (as hereinbefore defined) and a thio-substituted compound.

The metal sulphide scale may be iron sulphide. Alternatively, the metal sulphide may be lead sulphide or zinc sulphide or a combination thereof. The iron sulphide may be Troilite (FeS) or Pyrite (FeS₂). Alternatively, the iron sulphide may be Mackinawite (Fe₉S₈) or Phyrrhotite (Fe₇S₈).

The anion of the THP⁺salt should be compatible with the aqueous system. Preferred anions include sulphate, chloride, phosphate, bromide, fluoride, carbonate, citrate, lactate, tartrate, borate, silicate, formate and acetate. The anion should make the THP⁺salt water-soluble.

The thio-substituted compound is preferably thioglycollic acid (CAS No 68-11-1). Alternatively, the thio-substituted compound is selected from the group consisting of thio-substituted carboxylic acids or salts e.g. thiolactic acid, thiomalic acid and mercaptopyruvic acid; thio-substituted sulphonic acids e.g. mercaptoethane sulphonic acid; mercaptoalcohols e.g. mercaptoethanol; alkyl or aryl thiols (substituted and unsubstituted) e.g mercaptoethane and thiocresol; and thio-substituted heterocyclic compounds e.g. mercaptomethylimidazole, mercaptothiazoline and mercaptopyridine.

The formulation may further include a surfactant. The surfactant is preferably a cationic surfactant, for example quaternary ammonium compounds, N-alkylated heterocyclic compounds or quaternised amido-amines. Anionic, amphoteric or non-ionic surfactants may also be used. The use of ammonium salts may be substituted for an aminomethane phosphonate.

The formulation according to the invention is particularly useful in the prevention of corrosion of mild steel, copper and aluminium.

The present invention also provides, in a second aspect, a method for treatment of an aqueous system containing or in contact with a metal sulphide scale while concomitantly inhibiting the corrosion of surfaces in contact with said aqueous system, which method comprises the addition to said aqueous system of a scale and corrosion inhibiting amount of a formulation in accordance with the first aspect of the invention.

The aqueous system is preferably one used in enhanced oil recovery. Alternatively, the aqueous system is one used in industrial water systems, paper manufacturing systems and any aqueous system wherein corrosion caused by THP⁺salts occurs.

The present invention also provides, in a third aspect, a formulation consisting essentially of the reaction product of a THP⁺salt a thio-substituted compound, wherein the ratio of said THP⁺salt and said thio-substituted compound is between 1:1 and 750:1.

The formulation as described in the first aspect is preferably used in an effective amount up to 30% by weight as THP⁺. The amount used will vary by application but it may also be effectively used for low level applications e.g. 1 to 10000 ppm as a THP⁺salt or in high level applications as 1 to 30% as a THP⁺salt. In the second aspect THP⁺is preferably used in an effective amount of up to 30% by weight as a THP⁺salt with the co-addition of a thio-substituted compound in an effective amount of between 0.1 to 10000 ppm in relation to the volume of the system being treated.

The ratio of THP⁺to the thio-substituted compound in the formulation is typically in the range 1:1 to 750:1, more preferentially 15:1 to 300:1, most preferably 75:1 to 150:1.

The present invention will be illustrated, merely by way of example, as follows.

### EXAMPLE 1.

Blank Experiment: A 100 ml solution of 20% THPS (26.6 g TOLCIDE® PS75) and 1 g ammonium chloride in synthetic seawater was placed in a 120 ml screw-top jar. A pre-weighed mild steel coupon was immersed in the solution. The jar was then stored in a 50° C. oven for 48 hours. After this time the coupon was cleaned by gentle scrubbing in water, washed with acetone and dried in the oven. The coupons were then reweighed and the corrosion rate calculated according to the equation:

$$Rate = \frac{K \times W}{A \times T \times d}$$

W=Weight loss in g (to 0.1 mg)
A=Area in Cm² (to 0.01 cm²)
T=Time of exposure in hours
d=Density in g/cm³

K is a constant defined by the units in which the corrosion rate is required. For example:

| Units | K |
|---|---|
| Mpy—mils per year | 3.45 × 10⁶ |

This experiment was repeated with various levels of corrosion inhibitor added to the blank solution. The results are shown in the table below:

TABLE

| | Corrosion Rate |
|---|---|
| Experiment | mpy |
| Blank | 208 |
| Blank + 5000 ppm Inhibitor A | 77 |
| Blank + 5000 ppm Inhibitor B | 197 |
| Blank + 5000 ppm Inhibitor C | 116 |
| Blank + 5000 ppm Inhibitor D | 132 |
| Blank + 5000 ppm Inhibitor E | 88 |
| Blank + 5000 ppm Inhibitor F | 86 |
| Blank + 5000 ppm Inhibitor G | 28 |
| Blank + 1% Inhibitor E | 78 |
| Blank + 1% Inhibitor F | 74 |
| Blank + 1% Inhibitor G | 14 |
| Blank + 100 ppm Thioglycollic acid | 47 |
| Blank + 1000 ppm Thioglycollic acid | 38 |
| Blank + 1000 ppm Thioglycollic acid + | 23 |
| 1000 ppm quaternary ammonium chloride | |
| Blank + 2800 ppm Thioglycollic acid + | 17 |
| 1000 ppm quaternary ammonium chloride | |

Blank—A solution consisting of 20% THPS and 1% ammonium chloride in synthetic seawater.

Inhibitor A—Commercially available corrosion inhibitor comprising ethoxylated ammonium chloride, dibutyl thiourea and ethoxylated fatty acid.

Inhibitor B—Commercially available corrosion inhibitor comprising polyoxyethylene 2-ethylhexyl ether phosphate.

Inhibitor C—Oilfield corrosion inhibitor comprising fatty acids and Tall oil reaction products with diethylene triamine.

Inhibitor D—Commercially available corrosion inhibitor comprising a phosphonocarboxylic acid.

Inhibitor E—Standard commercially available oilfield corrosion inhibitor based on an amine alkoxylate.

Inhibitor F—Standard commercially available oilfield corrosion inhibitor comprising an amine ethoxylate and a quaternary ammonium chloride.

Inhibitor G—Standard commercially available oilfield corrosion inhibitor comprising thioglycollic acid and a quaternary ammonium chloride.

1. A formulation for use in the treatment of corrosion and metal sulphide scale deposits in aqueous systems, said formulation comprising a THP⁺salt and a thio-substituted compound.

2. A formulation as claimed in claim 1 in which the metal sulphide scale is iron sulphide, lead sulphide or zinc sulphide.

3-4. (canceled)

5. A formulation as claimed in claim 1 in which the THP⁺salt comprises an anion selected from the group consisting of sulphate, chloride, phosphate, bromide, fluoride, carbonate, citrate, lactate, tartrate, borate, silicate, formate and acetate.

6. A formulation as claimed in claim 1 in which the thio-substituted compound is selected from the group consisting of thio-substituted carboxylic acids or salts; thio-substituted sulphonic acids; substituted and unsubstituted alkyl and aryl thiols; thio-substituted heterocyclic compounds; and mercaptoethanols.

7. A formulation as claimed in claim 6 in which the thio-substituted compound is thioglycollic acid.

8. A formulation as claimed in claim 1 in which said formulation further includes a surfactant.

9. A formulation as claimed in claim 8 in which the surfactant is a cationic surfactant.

10. A formulation as claimed in claim 9 in which the cationic surfactant is selected from the group consisting of quaternary ammonium compounds, N-alkylated heterocyclic compounds, quaternised amido-amines, and amino methane phosphonate.

11. A formulation as claimed in claim 8 in which the surfactant is selected from the group consisting of anionic, amphoteric and non-ionic surfactants.

12. (canceled)

13. A method for treatment of an aqueous system containing or in contact with a metal sulphide scale while concomitantly inhibiting the corrosion of surfaces in contact with said aqueous system, which method comprises the addition to said aqueous system of a scale and corrosion inhibiting amount of a formulation in accordance with claim 1.

14. A method according to claim 13 in which the aqueous system is used in enhanced oil recovery.

15. A method as claimed in claim 13 in which the aqueous system is used in industrial water systems.

16. A method as claimed in claim 13 in which the aqueous system is used in paper manufacturing systems.

17. A formulation consisting essentially of the reaction product of a THP⁺salt and a thio-substituted compound, wherein the ratio of said THP⁺salt and said thio-substituted compound is between 1:1 and 750:1.

18. A method as claimed in claim 13 in which the THP⁺salt is added to the aqueous system in an effective amount of up to 30% by weight.

19. A formulation as claimed in claim 1 in which the ratio of the THP⁺salt to the thio-substituted compound is in the range of 1:1 and 750:1.

20-21. (canceled)

22. A formulation as claimed in claim 19 in which the thio-substituted compound is selected from the group consisting of thio-substituted carboxylic acids or salts; thio-substituted sulphonic acids; substituted and unsubstituted alkyl and aryl thiols; thio-substituted heterocyclic compounds; and mercaptoethanols.

23. A formulation as claimed in claim 22 in which said formulation further includes a surfactant.

24. A formulation as claimed in claim 23 in which the ratio of the THP⁺salt to the thio-substituted compound is in the range of 15:1 and 300:1.

25. A formulation as claimed in claim 23 in which the ratio of the THP⁺salt to the thio-substituted compound is in the range of 75:1 and 150:1.
